(19) United States
(12) Patent Application Publication
(10) Pub. No.: US 2014/0220403 A1
(43) Pub. Date: Aug. 7, 2014

(54) BATTERY PACK ASSEMBLY AND ELECTRONIC DEVICE HAVING THE SAME

(71) Applicant: Samsung SDI Co., Ltd., Yongin-si (KR)

(72) Inventor: Hun-Tae Ro, Yongin-si (KR)

(21) Appl. No.: 13/934,709

(22) Filed: Jul. 3, 2013

(30) Foreign Application Priority Data
Feb. 5, 2013 (KR) 10-2013-0012884

(51) Int. Cl. H01M 2/10

(52) U.S. Cl. CPC H01M 2/1022; H01M 2/1005
USPC 429/96

(57) ABSTRACT

A battery pack assembly includes a battery pack and an attachable-detachable portion. The battery pack has a first magnetic portion. The attachable-detachable portion has a second magnetic portion magnetically coupled to the first magnetic portion and attaches and detaches the battery pack. Accordingly, it is possible to provide a battery pack assembly and an electronic device having the same, in which the attachable-detachable portion and the battery pack are coupled to each other using the magnetic coupling between the first and second magnetic portions, so that it is possible to firmly perform coupling between the attachable-detachable portion and the battery pack and to easily separate the battery pack from the electronic device.

### CROSS-REFERENCE TO RELATED APPLICATIONS

This application claims priority to and the benefit of Korean Patent Application No. 10-2013-0012884, filed on Feb. 5, 2013, in the Korean Intellectual Property Office, the entire content of which is incorporated herein by reference.

### BACKGROUND

1. Field

Aspects of the present invention relate to a battery pack assembly and an electronic device having the same.

2. Description of the Related Technology

Recently, secondary batteries have been used as power sources of portable electronic devices. As the portable electronic devices are used in various fields, demands on secondary batteries have rapidly increased. The secondary batteries can be charged/discharged a plurality of times, and accordingly are economically and environmentally efficient.

A battery pack is typically firmly coupled to an electronic device in order to use the battery pack as a power source of the electronic device. When the battery pack is replaced or separately kept, the battery pack should be separated from the electronic device. That is, preferably, the battery pack and the electronic device should be strongly fixed to each other when the battery pack is used, and the battery pack is easily separated from the electronic device.

However, conventionally, a latch or the like was simply used, and therefore, the battery pack was not easily attached/detached to/from the electronic device.

### SUMMARY OF CERTAIN INVENTIVE ASPECTS

Embodiments provide a battery pack assembly for facilitating the attachment and detachment of a battery pack and an electronic device having the same.

According to an aspect of the present invention, there is provided a battery pack assembly, including: a battery pack having a first magnetic portion; and an attachable-detachable portion having a second magnetic portion magnetically coupled to the first magnetic portion and configured to attach and detaching the battery pack to and from an electronic device.

The attachable-detachable portion may include a fixed portion; a sliding portion mounted to the fixed portion so as to be slidingly moved; and a second magnetic portion positioned at the sliding portion.

The sliding portion may be slidingly moved in a slide groove formed in the fixed portion.

If the sliding portion is pushed to one side, the second magnetic portion magnetically coupled to the first magnetic portion may be moved together with the sliding portion, so that the magnetic coupling between the first and second magnetic portions are released.

The second magnetic portion may receive a shear force caused by a force pushing the sliding portion to one side.

The attachable/detachable portion may further include an elastic portion allowing the slide portion to return to its original position when the force pushing the sliding portion to the one side is released.

Ends of the elastic portion may be respectively connected to the sliding portion and the fixed portion.

The direction in which the first and second magnetic portions face each other may be different from a direction in which the magnetic coupling between the first and second magnetic portions is released.

The direction in which the first and second magnetic portions face each other may be perpendicular to a direction in which the magnetic coupling between the first and second magnetic portions is released.

The first magnetic portion may have a first polarity, and the second magnetic portion may include a first magnetic sub-portion having the first polarity and a second magnetic sub-portion having a second polarity opposite to the first polarity.

The first magnetic portion and the second magnetic sub-portion may be magnetically coupled to each other. If the sling portion is pushed to one side, the second magnetic portion may be moved together with the sliding portion, so that the first magnetic sub-portion faces the first magnetic portion, thereby releasing the magnetic coupling between the first and second magnetic portions.

According to an aspect of the present invention, there is provided an electronic device including the battery pack assembly.

The attachable-detachable portion may be fixed to the electronic device.

The electronic device may be an electric tool or charger.

A guide may be provided in the direction in which the battery pack is fastened to the electronic device, and a rib guided along the guide may be provided in the battery pack.

### BRIEF DESCRIPTION OF THE DRAWINGS

The accompanying drawings, together with the specification, illustrate certain embodiments of the present invention, and, together with the description, serve to explain the principles of the present invention.

FIG. 1 is a perspective view of a battery pack assembly according to an embodiment of the present invention.

FIGS. 2 and 3 are sectional views of the battery pack assembly shown in FIG. 1 when being viewed from the top surface thereof.

FIG. 4 is a perspective view of a battery pack assembly according to another embodiment of the present invention.

FIGS. 5 and 6 are sectional views of the battery pack assembly shown in FIG. 4 when being viewed from a top surface thereof.

FIG. 7 is a perspective view showing an electronic device having a battery pack assembly according to an embodiment of the present invention.

FIG. 8 is a sectional view of the electronic device and the battery pack assembly, shown in FIG. 7, when being viewed from the right side thereof.

FIG. 9 is a separated perspective view of the electronic device and the battery pack assembly, shown in FIG. 7.

### DETAILED DESCRIPTION OF CERTAIN INVENTIVE EMBODIMENTS

Other features and advantages of the present invention will become more fully apparent from the following detailed description, taken in conjunction with the accompanying drawings.

Terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best way.

According to the battery pack assembly and the electronic device having the same of the present invention, the magnetic coupling using the first magnetic portion of the battery pack and the second magnetic portion of the attachable/detachable portion is used, so that it is possible to improve the coupling between the first and second magnetic portions and to facilitate the separation of the battery pack.

Further, the attachment/detachment of the battery pack can be more easily performed, using the second magnetic portion including the first and second sub-magnetic portions.

In the following detailed description, only certain embodiments of the present invention have been shown and described, simply by way of illustration. As those skilled in the art would realize, the described embodiments may be modified in various ways, without departing from the spirit or scope of the present invention. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals generally refer to like elements.

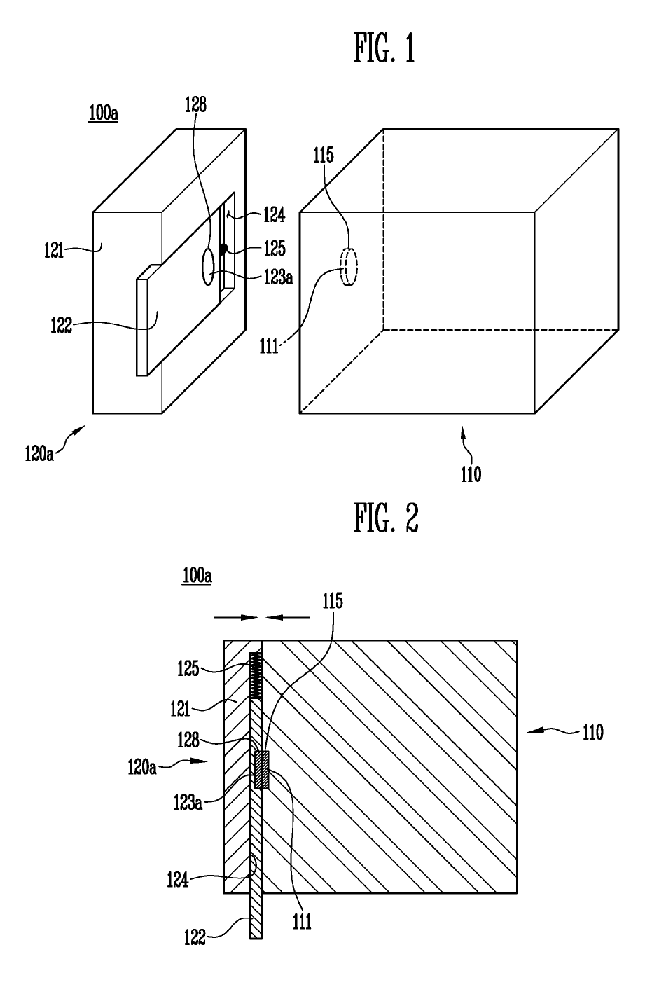

FIG. 1 is a perspective view of a battery pack assembly 100a according to an embodiment of the present invention. Hereinafter, the battery pack assembly 100a according to this embodiment will be described with reference to FIG. 1.

As shown in FIG. 1, the battery pack assembly 100a includes a battery pack 110 having a first magnetic portion 111, and an attachable/detachable portion 120a having a second magnetic portion 123a and attaching/detaching to/from the battery pack 110. The battery pack 110 may be attached/detached by magnetic coupling and release of the first and second magnetic portions 111 and 123a.

The battery pack 110 generates electrochemical energy by the movement of ions or electrons.

The battery pack 110 may include a bare cell, and the bare cell may be manufactured by accommodating an electrode assembly and an electrolyte in a battery case. The electrode assembly is formed by winding or stacking a positive electrode plate, a negative electrode plate and a separator interposed between these electrode plates. The electrode assembly generates energy through an electrochemical reaction between the electrode assembly and the electrolyte, and the energy is supplied to the outside of the bare cell through an electrode tab or the like.

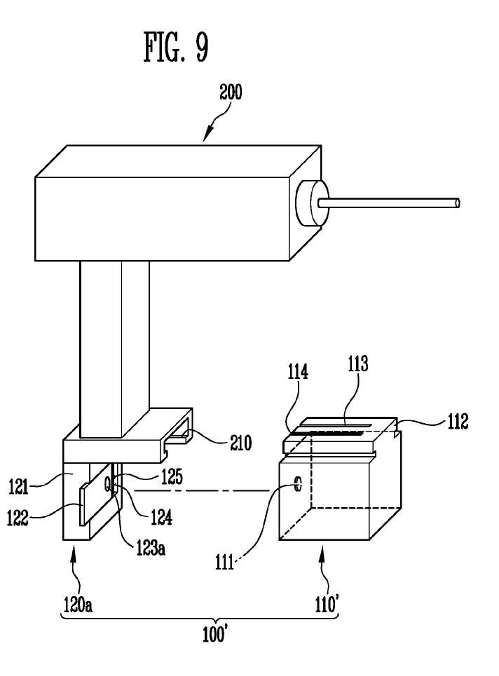

The battery pack 110 may include a protective circuit module that is electrically connected to the bare cell so as to control voltage or current in charging and discharging of the bare cell. The protective circuit module may be implemented as a circuit board having a circuit pattern formed thereon, and several electronic components may be mounted on one surface of the protective circuit module to perform a function of controlling the electrode assembly in the bare cell or cutting off a circuit in an abnormal operation of the electrode assembly. The battery pack 110 may have a pack terminal 113 (shown in FIGS. 8 and 9) extended from the protective circuit module and exposed to the outside of the battery pack 110, and an external electronic device 200 (shown in FIGS. 8 and 9) may be electrically connected to the battery pack 110 through the pack terminal 113. These will be described in detail later with reference to FIGS. 7 to 9.

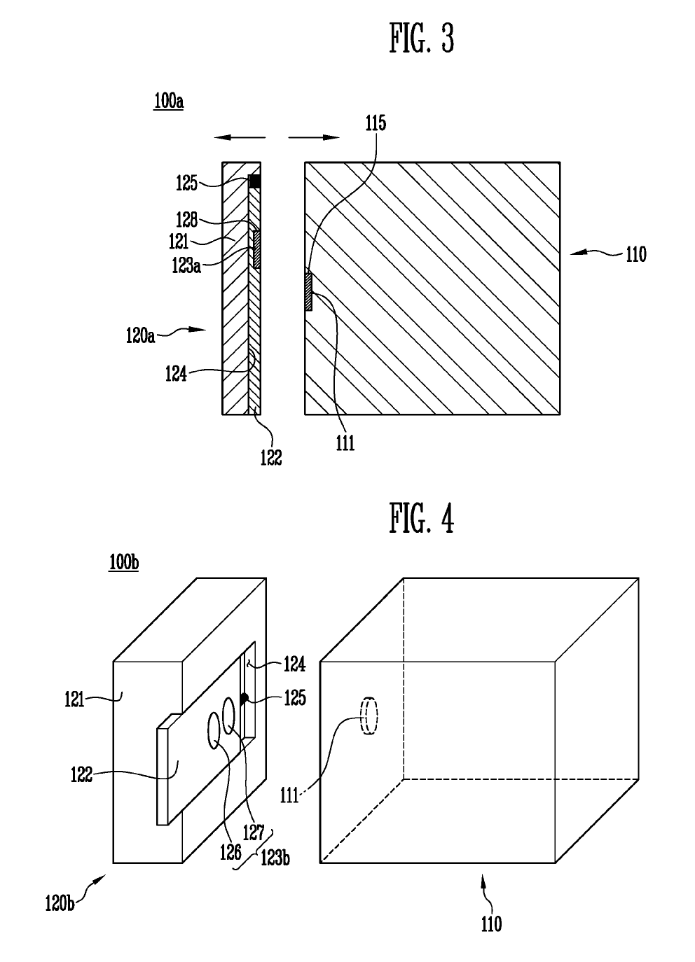

The first magnetic portion 111 may be provided to the battery pack 110. For example, the first magnetic portion 111 may be implemented as a permanent magnet, electromagnet or the like. The first magnetic portion 111 may be mounted on a first mounting portion 115 formed to be recessed in the battery pack 110. Accordingly, the first magnetic portion 111 can be implemented not to be protruded from the outer surface of the battery pack 110. That is, the outer surface of the first magnetic portion 111 and the outer surface of the battery pack 110 can substantially form the same plane (see FIG. 2).

The attachable/detachable portion 120a is for attaching/detaching the battery pack, and may include a fixed portion 121, a sliding portion 122 and the second magnetic portion 123a. The attachable/detachable portion 120a may further include an elastic portion 125.

The fixed portion 121 is relatively fixed as compared with the sliding portion 122, and the sliding portion 122 is slidingly movable with respect to the fixed portion 121. Specifically, a slide groove 124 may be formed in a wide surface of the fixed portion 121, and the sliding portion 122 may be inserted into the slide groove 124 so as to be slidingly movable along the slide groove 124. The thickness of the sliding portion 122 may be similar to the depth of the slide groove 124, and accordingly, the outer surface of the sliding portion 122 and the outer surface of the fixed portion 121 can substantially form the same plane.

The second magnetic portion 123a may be positioned on the sliding portion 122. The second magnetic portion 123a may be magnetically coupled to the first magnetic portion 111. Like the first magnetic portion 111, the second magnetic portion 123a may also be implemented as a permanent magnet, electromagnet or the like. When the first and second magnetic portions 111 and 123a are magnetically coupled to each other, the attachable/detachable portion 120a and the battery pack 110 may be coupled to each other. The second magnetic portion 123a may be mounted on a second mounting portion 128 formed to be recessed in the sliding portion 122. Accordingly, the second magnetic portion 123a can be implemented not to be protruded from the outer surface of the sliding portion 122. The outer surface of the sliding portion 122 and the outer surface of the fixed portion 121 can substantially form the same plane. Although it has been illustrated in FIG. 1 that each of the first and second magnetic portions 111 and 123a includes any one magnetic member, each of the first and second magnetic portions 111 and 123a may be configured in plural numbers. The polarities of surfaces through which the first and second magnetic portions 111 and 123a contact each other are opposite to each other, so that the first and second magnetic portions 111 and 123a can strongly attract each other.

The elastic portion 125 allows the sliding portion 122 to elastically return to its original position. For example, the elastic portion 125 may be mounted so that both ends of the elastic portion 125 are respectively connected to the sliding portion 122 and the fixed portion 121. When the sliding portion 122 is slidingly moved by an external force in the compressing direction of the elastic portion 125, and the external force is then released, the elastic portion 125 may push the sliding portion 122 in the extending direction thereof. Accordingly, the sliding portion 122 can return to its original position. The elastic portion 125 may be implemented with, for example, rubber, spring or the like.

FIGS. 2 and 3 are sectional views of the battery pack assembly 100a shown in FIG. 1 when being viewed from the top surface thereof. Hereinafter, the operation of the battery pack assembly 100a according to this embodiment will be described with reference to FIGS. 2 and 3.

As shown in FIG. 2, in a case where no external force exists, the first magnetic portion 111 of the battery pack 110 and the second magnetic portion 123a of the attachable/detachable portion 120a can be magnetically coupled to each other. For example, the surfaces of the first and second magnetic portions 111 and 123a, which face each other, have N and S polarities, respectively, so that the first and second magnetic portions 111 and 123a can be magnetically coupled to each other. The first magnetic portion 111 is positioned on the first mounting portion 115 and the second magnetic portion 123a is positioned on the second mounting portion 128. Thus, in a case where the first and second magnetic portions 111 and 123a are magnetically coupled to each other, the outer surface of the sliding portion 122 and the outer surface of the battery pack 110 can contact each other, thereby obtaining a more firm coupling between the first and second magnetic portions 111 and 123a.

As shown in FIG. 3, if the sliding portion 122 is pushed to one side, the sliding portion 122 is slidingly moved in the slide groove 124. In this case, the second magnetic portion 123a is moved together with the sliding portion 122, so that the magnetic coupling between the first and second magnetic portions 111 and 123a can be released. Thus, as the magnetic coupling between the first and second magnetic portions 111 and 123a is released, the attachable/detachable portion 120a and the battery pack 110 can also be separated from each other. If the second magnetic portion 123a is pushed by pushing the sliding portion 122, the second magnetic portion 123a receives a shear force from the sliding portion 122 so as to be separated from the first magnetic portion 111. In this case, the direction in which the magnetic coupling between the first and second magnetic portions 111 and 123a is released, i.e., the direction (direction ‘ [symbol] ’ in FIG. 3) in which the first and second magnetic portions 111 and 123a are separated from each other may be different from the direction (direction ‘ [symbol] ’ in FIG. 3) in which the first and second magnetic portions 111 and 123 face each other. That is, as shown in FIG. 3, the direction in which the first and second magnetic portions 111 and 123a are separated from each other is the same direction (direction in FIG. 3) as the direction in which the sliding portion 122 is moved, and may be perpendicular to the direction in which the first and second magnetic portions 111 and 123a face each other in FIG. 2.

In a case where each of the first and second portions 111 and 123a is implemented as a magnetic member such as an electromagnet or permanent magnet, the coupling in the surface-to-surface direction (direction ‘ [symbol] ’ in FIG. 3) is greater than that in the direction parallel with the surfaces (shear direction; direction ‘ [symbol] ’ in FIG. 3). Thus, in a case where the surfaces of the first and second magnetic portions 111 and 123a contact each other as shown in FIG. 2, a strong coupling between the first and second magnetic portions 111 and 123a is formed. On the other hand, if the sliding portion 122 is pushed as shown in FIG. 3, the second magnetic portion 123a receives the shear force, so that the magnetic coupling between the first and second magnetic portions 111 and 123a can be easily released.

If the force pushing one side of the sliding portion 122 is released after the battery pack 110 and the attachable/detachable portion 120a are separated from each other by releasing the magnetic coupling between the first and second magnetic portions 111 and 123a, the sliding portion 122 can return to its original position as shown in FIG. 2. In FIGS. 2 and 3, the sliding portion 122 is protruded from the fixed portion 121 in the state in which the first and second magnetic portions 111 and 123a are magnetically coupled to each other (FIG. 2), and the sliding portion 122 forms the same plane with the fixed portion 121 in the state in which the magnetic coupling between the first and second magnetic portions 111 and 123a is released (FIG. 3). However, this is provided for illustrative purposes, and the present invention is not limited thereto. For example, the sliding portion 122 may form the same plane with the fixed portion 121 in the state in which the first and second magnetic portions 111 and 123a are magnetically coupled to each other, and the sliding portion 122 may be protruded or recessed inward in the state in which the magnetic coupling between the first and second magnetic portions 111 and 123a is released. In this case, it is possible to more efficiently prevent the phenomenon that the sliding portion 122 is unexpectedly pressed.

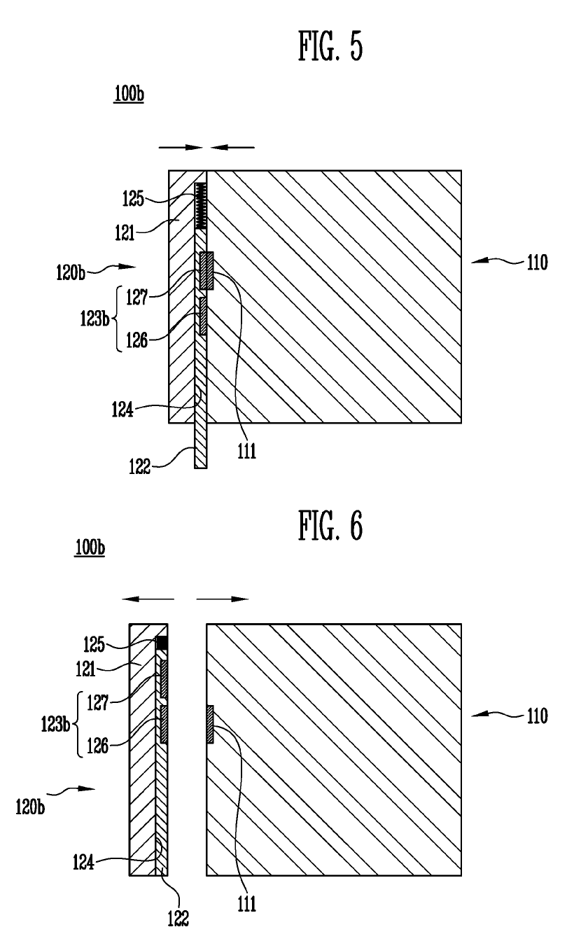

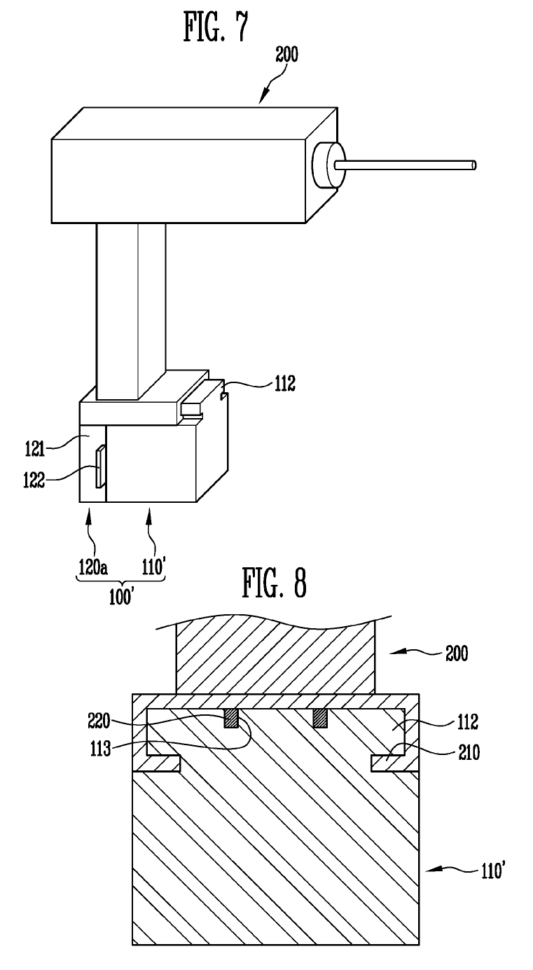

FIG. 4 is a perspective view of a battery pack assembly 100b according to another embodiment of the present invention. FIGS. 5 and 6 are sectional views of the battery pack assembly 100b shown in FIG. 4 when being viewed from a top surface thereof. The battery pack assembly 100b according to this embodiment will be described with reference to FIGS. 4 to 6. Components identical or corresponding to those of the aforementioned embodiment are designated by like reference numerals, and descriptions overlapping with the aforementioned embodiment are omitted.

As shown in FIGS. 4 to 6, the battery pack assembly 100b according to this embodiment includes a battery pack 110 having a first magnetic portion 111, and an attachable/detachable portion 120b having a second magnetic portion 123b. The second magnetic portion 123b includes a first magnetic sub-portion 126 and a second magnetic sub-portion 127, thereby facilitating attachment/detachment of the battery pack 110.

Specifically, the second magnetic portion 123b may include first and second magnetic sub-portions 126 and 127 having different polarities. For example, the first magnetic sub-portion 126 may have a first polarity and the second magnetic sub-portion 127 may have a second polarity opposite to the first polarity. The first and second magnetic sub-portions 126 and 127 may be arranged in parallel with the sliding direction of the sliding portion 122.

As shown in FIG. 5, when the first and second magnetic portions 111 and 123b are magnetically coupled to each other, the first magnetic sub-portion 126 having the first polarity and the second magnetic sub-portion 127 having the second polarity can be magnetically coupled to each other.

Next, as shown in FIG. 6, if the sliding portion 122 is pushed to one side, the second magnetic sub-portion 127 may be moved together with the sliding portion 122. Therefore, the magnetic coupling between the second magnetic sub-portion 127 and the first magnetic portion 111 may be released. In this case, the first and second magnetic sub-portions 126 and 127 are arranged in a line. Hence, if the sliding portion 122 is pushed to one side, the first magnetic sub-portion 126 faces the first magnetic portion 111. Since the both the first magnetic sub-portion 126 and the first magnetic portion 111 have the first polarity, the first magnetic sub-portion 126 and the first magnetic portion 111 may be pushed in the direction in which they are distant from each other (occurrence of a repulsive force). Thus, the battery pack 110 and the attachable/detachable portion 120b can be spaced apart from each other at a predetermined distance without separately applying an external force for separating the battery pack 110 and the attachable/detachable portion 120b from each other. Accordingly, it is possible to provide convenience in the attachment/detachment of the battery pack 110.

FIG. 7 is a perspective view showing an external electronic device 200 having a battery pack assembly 100′ according to an embodiment of the present invention. FIG. 8 is a sectional view of the electronic device 200 and the battery pack assembly 100′, shown in FIG. 7, when being viewed from the right side thereof. FIG. 9 is a separated perspective view of the electronic device 200 and the battery pack assembly 100′, shown in FIG. 7. Hereinafter, the electronic device 200 having the battery pack assembly 100′ according to this embodiment will be described with reference to FIGS. 7 to 9.

As shown in FIGS. 7 to 9, a battery pack 110′ and the battery pack assembly 100′ including the attachable/detachable portion 120a may be provided to, for example, an external electronic device 200 such as an electric tool or charger. Specifically, the attachable/detachable portion 120a is fixed to the electronic device 200, and the battery pack 110′ may be coupled to or separated from the electronic device 200 by the mutual coupling between the first and second magnetic portions 111 and 123a according to the movement of the sliding portion 122.

When each of the first and second portions 111 and 123a is implemented as a magnetic member as described above, a strong coupling may be provided in the surface-to-surface coupling, but a relatively weak coupling may be provided in the shear coupling. Therefore, when the battery pack 110′ is separated from the electronic device 200 in the moving direction (shear direction) of the sliding portion 122, the battery pack 110′ is too easily separated from the electronic device 200, and therefore, a safety accident may occur. For example, the battery pack 110′ may be pushed in the moving direction of the sliding portion 122 due to carelessness during an operation. In this case, the magnetic coupling between the first and second magnetic portions 111 and 123a may be easily released by the shear force, and hence the battery pack 110′ is easily separated from the electronic device 200. As a result, a safety accident may occur. Preferably, the separating direction of the battery pack 110′ is different from the moving direction of the sliding portion 122. More preferably, the separating direction of the battery pack 110′ may be set to the direction in which the coupling between the first and second magnetic portions 111 and 123a is strongest, i.e., the direction in which the first and second magnetic portions 111 and 123a face each other.

To this end, in this embodiment, a guide 210 may be formed in the electronic device 200, and a rib 112 may be formed in the battery pack 110′. In this case, the rib 112 may be inserted into an internal space made by the guide 210, and accordingly, the battery pack 110′ can be separated along only the direction in which the guide 210 is extended. Thus, the extending direction of the guide 210 is set identical to the direction in which the first and second magnetic portions 111 and 123a face each other, thereby preventing the phenomenon that the battery pack 110 is unexpectedly separated. In this case, if the sliding portion 122 is pushed, the second magnetic portion 123a receives the shear force to be moved. Hence, the magnetic coupling between the first and second magnetic portions 111 and 123a can be easily released. That is, the battery pack 110′ can be easily separated from the electronic device 200 only when a user desires.

The electrical coupling between the electronic device 200 and the battery pack 110′ may be implemented through a device terminal 220 and a pack terminal 113. For example, the device terminal 220 may be implemented in a protruded shape, and the pack terminal 113 may be implemented in a recessed groove shape. The device terminal 220 is inserted into the pack terminal 113 so that the power of the battery pack 110′ can be transferred to the electronic device 200. The pack terminal 113 may have an opening 114 provided at one side thereof so that the device terminal 220 can be slided in the attachment/detachment of the battery pack 110′.

Although it has been described in this embodiment that the second magnetic portion 123a is implemented with one member having one polarity, a case where the second magnetic portion 123b includes the first and second magnetic sub-portions 126 and 127 as shown in FIGS. 4 to 6 can be applied.

While the present invention has been described in connection with certain embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery pack assembly, comprising:
a battery pack having a first magnetic portion; and
an attachable-detachable portion having a second magnetic portion magnetically coupled to the first magnetic portion and configured to attach and detach the battery pack to and from an electronic device.

2. The battery pack assembly of claim 1, wherein the attachable/detachable portion includes:
a fixed portion;
a sliding portion mounted to the fixed portion so as to be slidingly moved; and
a second magnetic portion positioned at the sliding portion.

3. The battery pack assembly of claim 2, wherein the sliding portion is slidingly moved in a slide groove formed in the fixed portion.

4. The battery pack assembly of claim 2, wherein, if the sliding portion is pushed to one side, the second magnetic portion magnetically coupled to the first magnetic portion is moved together with the sliding portion, so that the magnetic coupling between the first and second magnetic portions are released.

5. The battery pack assembly of claim 4, wherein the second magnetic portion receives a shear force caused by a force pushing the sliding portion to one side.

6. The battery pack assembly of claim 4, wherein the attachable/detachable portion further includes an elastic portion allowing the sliding portion to return to its original position when the force pushing the sliding portion to the one side is released.

7. The battery pack assembly of claim 4, wherein ends of the elastic portion are respectively connected to the sliding portion and the fixed portion.

8. The battery pack assembly of claim 4, wherein a direction in which the first and second magnetic portions face each other is different from a direction in which the magnetic coupling between the first and second magnetic portions is released.

9. The battery pack assembly of claim 8, wherein the direction in which the first and second magnetic portions face each other is perpendicular to the direction in which the magnetic coupling between the first and second magnetic portions is released.

10. The battery pack assembly of claim 2, wherein the first magnetic portion has a first polarity, and the second magnetic portion includes a first magnetic sub-portion having the first polarity and a second magnetic sub-portion having a second polarity opposite to the first polarity.

11. The battery pack assembly of claim 10, wherein the first magnetic portion and the second magnetic sub-portion are magnetically coupled to each other, and
wherein, if the sliding portion is pushed to one side, the second magnetic portion is moved together with the sliding portion, so that the first magnetic sub-portion faces the first magnetic portion, thereby releasing the magnetic coupling between the first and second magnetic portions.

12. An electronic device comprising the battery pack of claim 1.

13. The electronic device of claim 12, wherein the attachable-detachable portion is fixed to the electronic device.

14. The electronic device of claim 12, wherein the electronic device is an electric tool or charger.

15. The electronic device of claim 12, wherein a guide is provided in a direction in which the battery pack is fastened to the electronic device, and a rib guided along the guide is provided in the battery pack.
